(19) United States
(12) Patent Application Publication
(10) Pub. No.: US 2009/0021814 A1
(43) Pub. Date: Jan. 22, 2009

(54) HOLOGRAM APPARATUS AND METHOD THEREOF

(75) Inventors: Chi-Yun CHEN, Taipei City (TW); Tzi-Dar CHIUEH, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/173,058

(22) Filed: Jul. 15, 2008

Related U.S. Application Data
(60) Provisional application No. 60/950,361, filed on Jul. 18, 2007.

(51) Int. Cl. G03H 1/12

(52) U.S. Cl. 359/21; 359/25; 359/30

(57) ABSTRACT

Hologram recording and reconstruction apparatuses and method thereof are provided. The hologram recording apparatus comprises a laser source, a spatial light modulator, and a Fourier lens. The laser source provides a coherent light beam. The spatial light modulator receives m-bits data to only determine a (p×q) block comprising ON-pixels less than OFF-pixels, and receives the coherent light beam to modulate with the (p×q) block to generate the signal beam. The Fourier lens focuses the signal beam on the hologram recording medium, so that when the focused signal beam and a focused reference beam is modulated together, the hologram data is generated to be recorded on the hologram recording medium.

### CROSS REFERENCE TO RELATED APPLICATIONS

This application claims the benefit of U.S. Provisional Application No. 60/950,361, filed Jul. 18, 2007, the entirety of which is incorporated by reference herein.

### BACKGROUND OF THE INVENTION

1. Field of the Invention

The invention relates in general to holographic data storage, and in particular, to a hologram apparatus and method thereof for recording and reconstructing data to and from a holographic memory.

2. Description of the Related Art

Holographic data storage (HDS) provides promising resolution for next-generation digital data storage systems with high storage capacity holding more than 200 GB data in each HDS disk and fast data transfer speed exceeding 160 Mb/sec. HDS systems are page-based systems encoding information in two-dimensional (2D) format, and recording the encoded information in three-dimensional (3D) spaces in HDS storage media made up of photorefractive materials.

Conventionally, HDS data are encoded into 2D format for recording on a HDS disk using 6:8 balanced block code and 8:12 balanced strip code. For the 6:8 balanced block code, 6-bit input data are modulated to (2×4) array data with exactly four ON-pixels and four OFF-pixels, the 6-bit input data and modulated (2×4) array has a one-to-one mapping correspondence, and the minimum Hamming distance for any two consecutive modulated (2×4) codewords is 2. For the 8:12 balanced strip code, 8-bit input data are modulated to (2×6) array with exactly equal numbers of ON-pixels and OFF-pixels by a finite state machine and decoded by a Viterbi decoder, and the minimum Hamming distance between two consecutive modulated (2×6) codewords is 4. To achieve as high code rate as the 6:8 balanced block code and as good performance as the 8:12 balanced strip code, the 9:12 pseudo balanced block code (PBC) is proposed, with 9-bit input data being modulated to (3×4) array with substantially equal numbers of ON-pixels and OFF-pixels by a finite state machine and decoded by a Viterbi decoder, and the minimum Hamming distance between two consecutive modulated (3×4) codewords being 4. The 8:12 balanced strip code with code rate lower than ¾, the code rates of the 6:8 balanced block code and the 9:12 pseudo balanced block, is less efficient.

The increased storage density of the HDS systems comes at a cost of increased crosstalk interference between pixels, known as inter-pixel interference (IPI), and decreased noise immunity for each data. Thus, a need exists for a coding scheme for the holographic data storage systems capable of recording and reconstructing data with decreased IPI and increased noise immunity.

### BRIEF SUMMARY OF THE INVENTION

A detailed description is given in the following embodiments with reference to the accompanying drawings.

A hologram recording apparatus recording hologram data generated from a reference beam and a signal beam on a hologram recording medium is provided. The hologram recording apparatus comprises a laser source, a spatial light modulator, and a Fourier lens. The laser source provides a coherent light beam. The spatial light modulator receives m-bits data to only determine a (p×q) block comprising ON-pixels less than OFF-pixels, and receives the coherent light beam to modulate with the (p×q) block to generate the signal beam. The Fourier lens focuses the signal beam on the hologram recording medium, so that when the focused signal beam and a focused reference beam is modulated together, the hologram data is generated to be recorded on the hologram recording medium.

According to another embodiment of the invention, a hologram reconstruction apparatus decoding hologram data in a hologram recording medium is disclosed. The hologram reconstruction apparatus comprises an optical detector, a candidate selector, a best-codeword selector, and a message generator. The optical detector detects reconstructed page data according to the hologram data and a reference beam. The candidate selector, coupled to the optical detector, computes a Hamming distance between the reconstructed page data and each candidate page data, and outputs the candidate page data when the Hamming distance is less than a predetermined Hamming distance threshold. The best-codeword selector, coupled to the candidate selector, estimates a Euclidian distance between each outputted candidate page data and the reconstructed page data, and determines a minimum Euclidian distance thereof The message generator, coupled to the best codeword selector, outputs a message data corresponding to the outputted page candidate data with the minimum Euclidian distance.

According to yet another embodiment of the invention, a holographic modulation method modulating 1-dimentional data into 2-dimentional data to generate hologram data to be recorded on a hologram recording medium is provided, the modulation method comprises a spatial light modulator receiving m-bits data to only determine a (p×q) block comprising ON-pixels less than OFF-pixels, the spatial light modulator receiving a coherent light beam to modulate with the (p×q) block to generate a signal beam, and a Fourier lens focusing the signal beam on the hologram recording medium, so that when the focused signal beam and a focused reference beam is modulated together, the hologram data is generated to be recorded on the hologram recording medium.

### BRIEF DESCRIPTION OF THE DRAWINGS

The invention can be more fully understood by reading the subsequent detailed description and examples with references made to the accompanying drawings, wherein:

FIG. 1 is a block diagram of an exemplary holographic data storage system according to the invention.

FIG. 2 shows the data recording scheme for the holographic data storage system in FIG. 1.

FIG. 3 shows the data reading scheme for the holographic data storage system in FIG. 1.

FIG. 4 is a block diagram illustrating channel impairments in a holographic data storage system.

FIG. 5 shows part of exemplary hologram data pages according to the invention.

FIG. 6 is a block diagram of exemplary demodulator 144 in FIG. 1.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

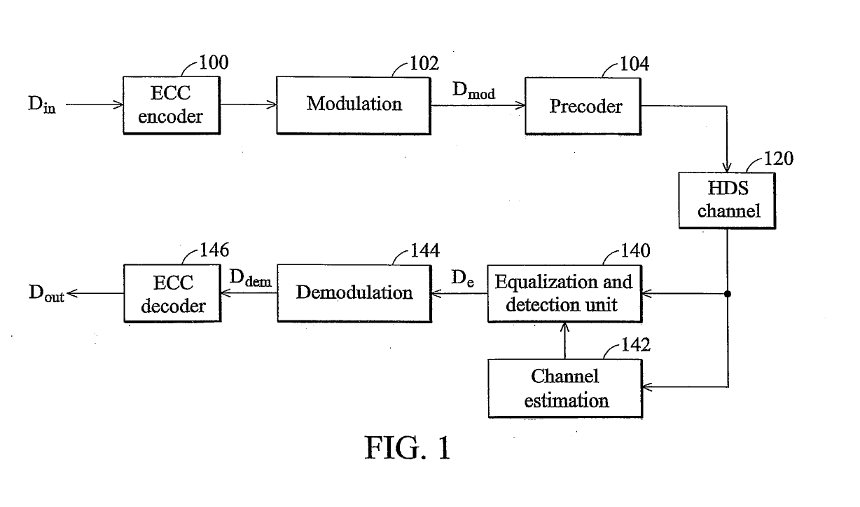

FIG. 1 is a block diagram of an exemplary holographic data storage system according to the invention, comprising ECC encoder 100, modulator 102, precoder 104, HDS channel 120, equalization and detection unit 140, channel estimator 142, demodulator 144, and ECC decoder 146. ECC encoder 100 is coupled to modulator 102, precoder 104, HDS channel 120, equalization and detection unit 140 and channel estimator 142, demodulator 144, and subsequently to ECC decoder 146

ECC encoder 100 receives ID data stream Dₘ to perform error correction code (ECC) encoding thereon by adding parity bits, maintaining data integrity across noisy channels and less-than-reliable storage media. Modulator 102 then obtains the ECC coded data to perform data segmentation thereon and modulate the data segments into 2D data codewords D_{mod} compliant with the 6:8 variable weight modulation scheme in the invention, in which the data segments are 6-bit data and 2D data codewords D_{mod} are (2×4) page data. Page data D_{mod} may be passed to precoder 104 to provide further error code protection and protect modulated data D_{mod} from the inter-pixel interference during the holographic data storage processes. A spatial light modulator (SLM) in HDS channel 120 (not shown) then transforms the coded page data D_{mod} from electrical signals into optical signals for data storage (not shown) in HDS channel 120. Upon data retrieval, the hologram data are processed in equalization and detection unit 140 and channel estimator 142 for channel estimation and equalization to generate equalized page data Dₑ. HDS channel 120 also comprises an optical detector (not shown) detecting the reconstructed page data on the hologram disc. Equalization and detection unit 140 comprises an equalizer equalizing the reconstructed page data for demodulation and a detector recovering coded page data D_{mod} by using an algorithm having an estimation or detection criterion. Demodulator 144 demodulates equalized data Dₑ according to the 6:8 variable-weight (VW) coding scheme to output demodulated message data D_{dem}, pass it to ECC decoder 146 for ECC decoding and producing recovered data Dₒᵤₜ.

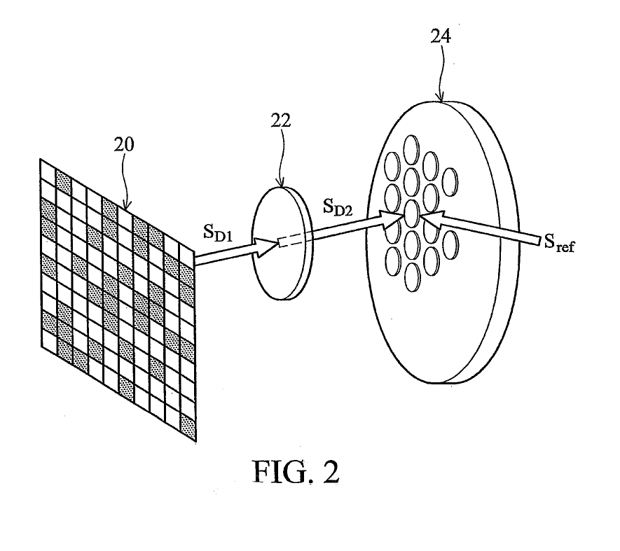

In HDS channel 120, 2D page data D_{mod} is recorded on photorefractive materials for data storage. FIG. 2 shows the data recording scheme in HDS channel 120 in FIG. 1. The hologram apparatus in FIG. 2 comprises spatial light modulator (SLM) 20 and Fourier lens 22 to record the hologram data on holographic disc 24. Upon recording, a coherent laser beam emitted from a laser light source (not shown) is converted to substantially parallel lights filtered through spatial light modulator 20, while spatial light modulator 20 provides a block matrix consisting of ON pixels and OFF pixels determined by 2D page data D_{mod}. The ON and OFF pixels may correspond to Bit 1 and 0 in page data D_{mod}. The parallel laser lights filter through spatial light modulator 20 to provide signal beams SDI, focused on holographic disc 24 by Fourier lens 22. Meanwhile, parallel reference beams S_{ref} are sent to holographic disc 24 at an angle. The converged signal beams SD2 and reference beams S_{ref} are modulated to produce interference patterns to be stored on photorefractive material holographic disc 24.

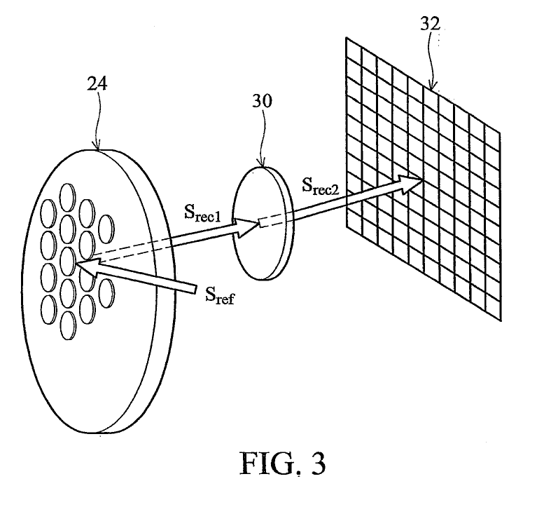

Upon data recovery, the page data D_{mod} on holographic disc 24 are reproduced by the data reproduction scheme in FIG. 3. The hologram apparatus in FIG. 2 comprises Fourier lens 30 and optical detector array 32 to recover the page data D_{mod} on holographic disc 24 by illuminating holographic disc 24 by reference beam S_{ref} with the identical angle used for recording such that beam S_{ref} is reconstructed substantially identical to page data D_{mod}. Reconstructed beam S_{ref} is sent through Fourier lens 30 to produce substantially parallel reconstructed beams S_{ref} detected by optical detector array 32. Optical detector array 32 photoelectrically converts the received optical image into electrical image signal for equalization in the equalizer (not shown). The equalized data are sent to demodulation unit 144 to demodulate the 2D page data back to ID data D_{dem}.

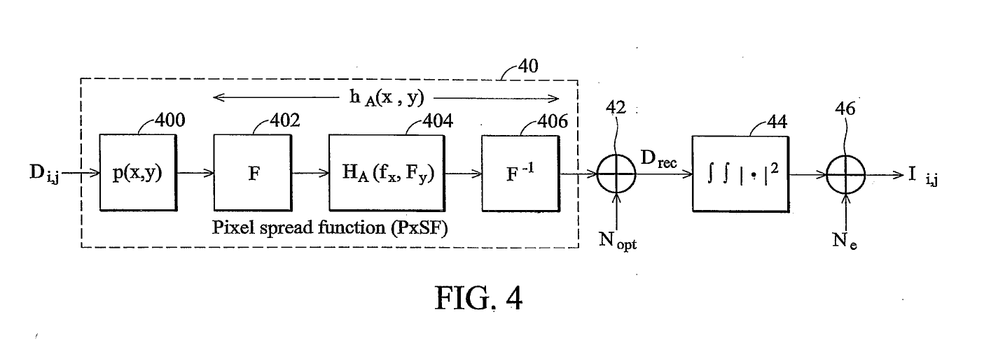

During data recording and reproduction, channel impairments in HDS channel 120 including IPI and additive white Gaussian noise (AWGN) noise affect quality of the reconstructed data for demodulation and decoding. FIG. 4 is a block diagram illustrating a channel model in the hologram apparatus in FIG. 1, comprising primarily of three main sections, namely (1) SLM pixel shape function denoted by p(x, y), (2) aperture impulse response denoted by H_{A}(X, y), and (3) integration function in optical detector unit 32. The SLM pixel shape function is a 2D rectangular function with the interval set as the width of effective SLM pixels. The aperture impulse response is a 2D sinc function. The convolution of SLM pixel shape function p(x, y) and aperture impulse response H_{A}(X, y) is known as pixel spread function (PxSF) 40, the major causes of the IPI effect. Each pixel D_{i,j} in spatial light modulator 20 takes on +1 to carry bit 1 or 1/ε for bit 0, where ε is an amplitude contrast ratio of spatial light modulator 20. The reconstructed data I_{i,j} is expressed by:

$${I}_{i , j} = \int \int {\vert [ {\sum }_{k} {\sum }_{l} {D}_{k , l} p ( x - k Δ , y - l Δ ) ] ⊗ {h}_{A} ( x , y ) \vert}^{2} d x d y \qquad [ 1 ]$$

where Δ is the pixel spacing between pixels in spatial light modulator 20. The integration range of equation [1] depends on the active area of optical detector array 32. Other channel impairments come from noise sources including optical and electrical noise in the HDS channel. The optical noise is inserted before the detector array integration and is of Rician distribution. The electrical noise with Guassian power density function (PDF) is then added after the received signals have been transformed back to electrical form.

Through the HDS channel, codewords generated by modulation encoder are corrupted mainly by the IPI effect, referred to as the signal interference between pixels due to different light intensity. Since OFF-pixels have very low intensity while ON-pixels have much higher intensity, OFF-pixels are more vulnerable to interference from ON-pixels. In other words, IPI effect is not balanced for these two types of pixels. Therefore, the number of ON-pixels is reduced as much as possible to mitigate the IPI effect.

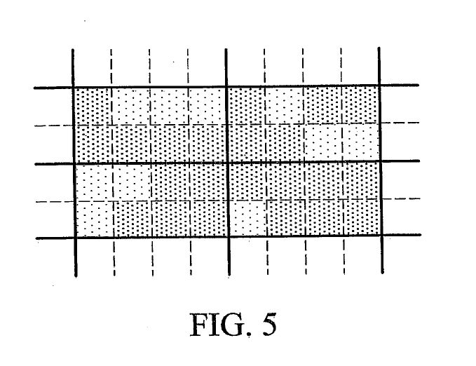

The 6:8 variable-weight modulation code incorporated in the HDS system in FIG. 1 is a fixed-length block code that encodes 6-bit data to a (2×4) rectangular block consisting ON pixels less than OFF-pixels, so that the pixel interference from ON-pixels to OFF-pixels is reduced. In the embodiment, only one or three ON-pixels are included in each (2×4) data block. FIG. 5 shows exemplary hologram data pages according to the invention, comprising only one or three ON-pixels. There are C₁⁸=8 codewords with one ON pixel and C₃⁸=56 codewords with three ON pixels. The major issues in designing the 64 (=2⁶) codewords in the 6:8 VW modulation code include bit-error rate (BER) and codeword sparseness. In principle, the mapping is constructed with reference to the Gray code. For two 6-bit messages differing by exactly one bit, the Hamming distance (HD) of their corresponding codewords has minimum value. In the embodiment, each (2×4) data block only comprises one or three ON-pixels, and the minimal Hamming distance between two 2×4 blocks is 2, corresponding to two 6-bit data differing by exactly 1 bit. Moreover, these two (2×4) codewords after being corrupted by IPI have a small Euclidean distance. This way the most probable decoding errors are likely to contribute only one error bit, thus minimizing the BER.

Although FIG. 5 shows a 6:8 VW modulation scheme, other (m:n) variable weight modulation scheme can be implemented according to the identical principle of the invention, where the m-bit input data is modulated into the n modulated codeword comprising a (p×q) block, with the number of ON-pixels being less than the number of OFF-pixels therein.

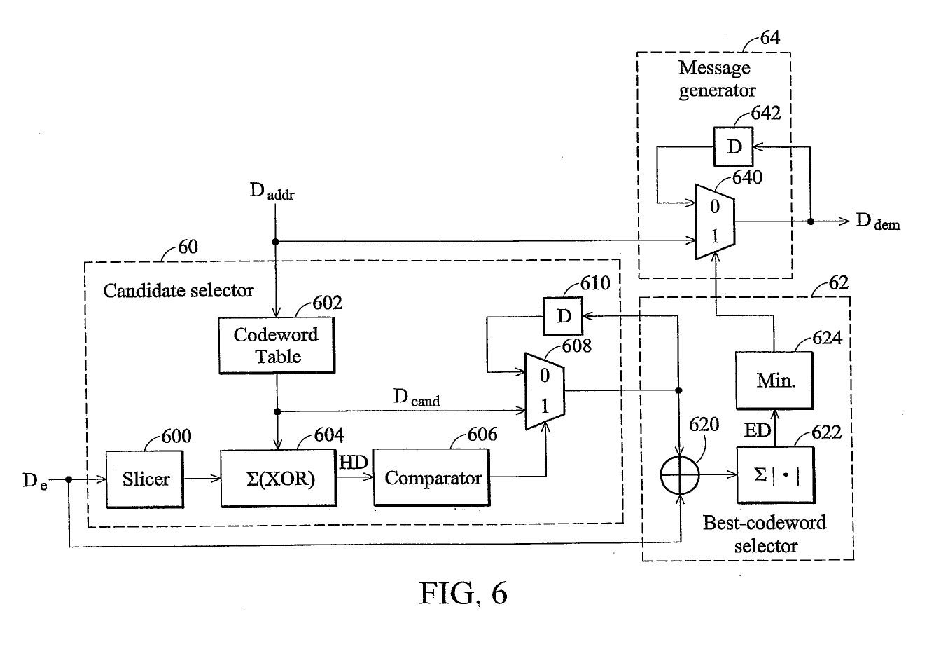

FIG. 6 is a block diagram of exemplary demodulator 144 in FIG. 1, decoding hologram data in a hologram recording medium, comprising candidate selector 60, best-codeword selector 62, and message generator 64. Candidate selector 60 is coupled to best-codeword selector 62, and subsequently to message generator 64.

Candidate selector 60 computes a Hamming distance (HD) between equalized page data De and each candidate page data D_{cand}, and outputs the candidate page data D_{cand} when Hamming distance HD is less than a predetermined Hamming distance threshold. Best-codeword selector 62 then estimates Euclidian distance (ED) between each outputted candidate page data D_{cand} and the equalized page data Dₑ, and determines a minimum Euclidian distance thereof Message generator 64 outputs message data D_{dem} corresponding to the outputted page candidate data with the minimum Euclidian distance.

Candidate selector 60 comprises slicer 600, 602, Hamming distance calculator 604, comparator 606, and multiplexer 608, and delay 610. Slicer 600 and 602 are coupled to Hamming distance calculator 604, comparator 606, multiplexer 608, and then to delay 610.

Slicer 600 receives equalized page data De from preceding data equalization and detection stage to determine each pixel value therein. Hamming distance calculator 604 performs XOR operation on corresponding pixels in the equalized page data Dₑ and candidate page data D_{cand} from codeword table 602 and sums all XOR results to provide HD. Comparator 606 compares HD and the predetermined Hamming distance threshold to enable a first select signal when HD is less than the predetermined Hamming distance threshold. Multiplexer 608 receives the first select signal to select between candidate page data D_{cand} and previous candidate page data stored in delay 610 for output. Delay 610 may be a register.

Best-codeword selector 62 comprises difference unit 620, summation unit 622, and minimum unit 624. Difference unit 620 is coupled to summation unit 622, and then to minimum unit 624.

Difference unit 620 receives the outputted candidate page data D_{cand} and equalized page data Dₑ to calculate a difference between corresponding pixels therein, which are passed to summation unit 622 to sum all differences to generate ED. In minimum unit 624, ED for all outputted candidate page data D_{cand} are received to determine the minimum ED thereof.

Message generator 64 comprises multiplexer 640 and delay 642 coupled thereto. Multiplexer 640 receives the first select signal to select between a candidate message data and previous message data stored in delay 642 for output D_{dem}. Delay 642 may be a register.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A hologram recording apparatus, recording hologram data generated from a reference beam and signal beam on a hologram recording medium, and comprising:
a laser source, providing a coherent light beam;
a spatial light modulator, receiving m-bit data to only determine a (p×q) block comprising ON-pixels less than OFF-pixels, and receiving the coherent light beam to modulate with the (p×q) block to generate the signal beam; and
a Fourier lens, focusing the signal beam on the hologram recording medium, so that when the focused signal beam and a focused reference beam is modulated together, the hologram data is generated to be recorded on the hologram recording medium.

2. The hologram recording apparatus of claim 1, wherein the m-bits data is a 6-bit data, and (p×q) block is a (2×4) block.

3. The hologram recording apparatus of claim 2, wherein the 2×4 block comprises 1 or 3 ON-pixels.

4. The hologram recording apparatus of claim 2, wherein any two 2×4 blocks corresponding to two 6-bit data differing by exactly 1 bit have a minimal Hamming distance of 2.

5. The hologram recording apparatus of claim 2, wherein the special light modulator receives the 6-bits data to determine the 2×4 block according to a lookup table.

6. The hologram recording apparatus of claim 2, wherein the hologram recording medium is a photorefractive material.

7. A hologram reconstruction apparatus, decoding hologram data in a hologram recording medium, and comprising:
an optical detector, detecting reconstructed page data according to the hologram data and a reference beam;
a candidate selector, coupled to the optical detector, computing a Hamming distance between the reconstructed page data and each candidate page data, and outputting the candidate page data when the Hamming distance is less than a predetermined Hamming distance threshold;
a best-codeword selector, coupled to the candidate selector, estimating an Euclidian distance between each outputted candidate page data and the reconstructed page data, and determining a minimum Euclidian distance thereof; and
a message generator, coupled to the best codeword selector, outputting a message data corresponding to the outputted page candidate data with the minimum Euclidian distance.

8. The hologram reconstruction apparatus of claim 7, wherein the candidate selector comprises a lookup table, and receives a candidate message data to determine the candidate page data according to the lookup table.

9. The hologram reconstruction apparatus of claim 7, further comprising an equalizer, coupled to the optical detector, equalizing the reconstructed page data.

10. The hologram reconstruction apparatus of claim 7, wherein the candidate selector comprises:
a slicer, receiving the reconstructed page data to determine each pixel value therein;
an exclusive OR unit, coupled to the slicer, performing XOR operation on each corresponding pixel in the reconstructed page data and the candidate page data and summing all XOR results to provide the Hamming distance;
a comparator, coupled to the exclusive OR unit, enabling a first select signal when the Hamming distance is less than the predetermined Hamming distance threshold;
a first multiplexer, coupled to the comparator, receiving the first select signal to select between the candidate page data and previous candidate page data for output; and
a first delay cell, coupled to the first multiplexer, storing the previous candidate page data.

11. The hologram reconstruction apparatus of claim 7, wherein the first delay cell is a register.

12. The hologram reconstruction apparatus of claim 7, wherein the best-codeword selector comprises:
a difference unit, receiving the outputted candidate page data and the reconstructed page data to calculate a difference between each corresponding pixel therein;
a summation unit, coupled to the difference unit, summing all differences to generate the Euclidean distance; and
a minimum unit, coupled to the summation unit, receiving the Euclidean distances for all outputted candidate page data to determine the minimum Euclidian distance thereof.

13. The hologram reconstruction apparatus of claim 7, wherein the message generator comprises:
a second multiplexer, coupled to the best-codeword selector, receiving the first select signal to select between a candidate message data and previous message data for output; and
a second delay cell, coupled to the second multiplexer, storing the previous message data.

14. The hologram reconstruction apparatus of claim 7, wherein the reconstructed page data and the candidate page data are (2×4) data blocks, and the message data is a 6-bit data.

15. A holographic modulation method, modulating 1-dimentional data into 2-dimentional data to generate hologram data to be recorded on a hologram recording medium, and comprising:
a spatial light modulator receiving m-bit data to only determine a (p×q) block comprising ON-pixels less than OFF-pixels;
the spatial light modulator receiving a coherent light beam to modulate with the (p×q) block to generate a signal beam; and
a Fourier lens focusing the signal beam on the hologram recording medium, so that when the focused signal beam and a focused reference beam is modulated together, the hologram data is generated to be recorded on the hologram recording medium.

16. The holographic modulation method of claim 15, wherein the m-bits data is a 6-bit data, and (p×q) block is a (2×4) block.

17. The holographic modulation method of claim 16, wherein the 2×4 block comprises 1 or 3 ON-pixels.

18. The holographic modulation method of claim 16, wherein any two 2×4 blocks corresponding to two 6-bit data differing by exactly 1 bit have a minimal Hamming distance of 2.

19. The holographic modulation method of claim 16, wherein the determination of the 2×4 block is according to the 6-bit data and a lookup table.

20. The holographic modulation method of claim 16, wherein the hologram recording medium is a photorefractive material.
